(19) United States
(12) Patent Application Publication
(10) Pub. No.: US 2026/0330232 A1
(43) Pub. Date: Oct. 22, 2026

(54) ACTIVE MULTI-PREFERENCE OPTIMIZATION FOR TRAINING OF MACHINE LEARNING MODELS

(71) Applicant: Microsoft Technology Licensing, LLC, Redmond, WA (US)

(72) Inventors: Xuchao ZHANG, Sammamish, WA (US); Saravanakumar RAJMOHAN, Redmond, WA (US); Chetan BANSAL, Seattle, WA (US); Taneesh GUPTA, Bengaluru (IN)

(21) Appl. No.: 19/181,584

(22) Filed: Apr. 17, 2025

(51) Int. Cl. G06N 3/088

(52) U.S. Cl. CPC G06N 3/088

(57) ABSTRACT

This invention relates to a method and system for Active Multi-Preference Optimization (AMPO) in training language models. The method involves generating multiple candidate responses for a given query and selecting a subset of responses that are most informative for training. The selection process includes identifying a highest-reward response as a positive example and employing strategies such as clustering and weighted selection to choose negative responses. The selected responses are used to compute a weighted contrastive loss function, which updates the model's parameters to improve alignment with human preferences. This approach enhances training efficiency by reducing computational overhead and improving model performance through targeted data selection and optimization.

### TECHNICAL FIELD

Embodiments pertain to artificial intelligence (AI) and machine learning technologies. Some embodiments relate to preference optimization methods for enhancing model alignment by reducing alignment biases. Some additional embodiments relate to selecting a subset of possible responses for training the model.

### BACKGROUND

Machine learning models are computational algorithms designed to identify patterns and make decisions based on data. These models are integral to a wide range of applications, including natural language processing, image recognition, and predictive analytics. By learning from large datasets, machine learning models can improve their performance over time, making them valuable tools in various industries such as healthcare, finance, and technology.

One of the key challenges in developing machine learning models is ensuring that they align with specific performance criteria and expectations such as human expectations. This alignment is crucial for applications where the model's output directly impacts operational efficiency or decision-making processes. To address this, various techniques have been developed to optimize model parameters based on preference data.

Direct Preference Optimization (DPO) is a method that simplifies the alignment process by directly optimizing a contrastive loss over paired preference data. Unlike traditional reinforcement learning approaches, DPO does not require explicit reward functions, making it computationally efficient and suitable for datasets with limited preference annotations. This method has become widespread in aligning models with predefined criteria, enabling them to generate outputs that are more consistent with desired outcomes.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates a schematic showing the iterative nature of Active Multi-Preference Optimization according to some examples of the present disclosure.

FIG. 2 shows a machine-learning model system according to some examples of the present disclosure.

FIG. 3 shows a flowchart of a method for Active Multi-Preference Optimization according to some examples of the present disclosure.

FIG. 4 shows a computing device that incorporates a training component and an inference component according to some examples of the present disclosure.

FIG. 5 illustrates a block diagram of an example machine upon which any one or more of the techniques discussed herein may be performed.

### DETAILED DESCRIPTION

Training of language models face several significant challenges. The traditional DPO approach relies on pairwise comparisons between responses to a given query. When models only see two examples at a time-one preferred and one non-preferred-they can end up overfitting to specific characteristics rather than learning the broader patterns that reflect genuine quality differences. These methods also struggle to make full use of available training data, particularly when there are multiple responses of varying quality levels. Simply categorizing responses as acceptable or unacceptable does not utilize information about how much better or worse certain responses are compared to others. This is especially problematic when working with datasets that include detailed quality ratings, as valuable training signals from exceptionally high-quality or notably low-quality responses get overlooked.

Multi-preference optimization (MPO) is emerging as an alternative framework to DPO for better aligning language models with human values, going beyond traditional pairwise or binary feedback mechanisms. Multi-preference approaches exploit the fact that there can be multiple acceptable (and multiple suboptimal) responses for a single query. By contrasting an entire group of responses simultaneously, these methods mitigate alignment bias and capture more nuanced reward distributions.

One approach to addressing these challenges is the Simultaneous Weighted Preference Optimization (SWEPO) method, which optimizes language model training by incorporating multiple responses with varying quality levels through weighted group contrastive alignment. The method calculates mean reward scores from multiple responses associated with each query and computes deviations of each response's reward score from the mean. These deviations are used to partition responses into positive and negative sets. The responses are then weighted based on their deviation from the mean, with greater weight given to responses that deviate more significantly from the average quality. These weights can be calculated using either an exponential function of the deviation or a power function with parameter p E {0,1,2}. The weights are incorporated into a weighted contrastive loss function that simultaneously considers multiple positive and negative responses. This loss function is then used to update the model parameters through optimization, resulting in a model that better captures the full spectrum of response quality.

The approach enables more nuanced training by emphasizing responses that are notably better or worse than average, while still maintaining the contribution of responses closer to the mean quality level. This makes more efficient use of training data by considering multiple responses simultaneously and reduces alignment bias through comprehensive quality assessment. The method solves optimization challenges by prioritizing the most informative examples during training while still maintaining consideration of the full response spectrum. The technical solution provided by SWEPO addresses the challenge of alignment bias in machine learning models by employing a weighted group contrastive loss function that assigns weights based on deviation from mean reward scores, allowing for simultaneous consideration of multiple preferences and reducing various types of alignment biases.

In some examples, the same model that is being optimized also generates the data it uses for further training. This is called “on-policy,” or “self-play” in other domains. On-policy generation brings the advantage of constantly matching the training distribution to the model's current policy. Unlike offline data-collection strategies that rely on older or external model snapshots, on-policy methods dynamically adapt to how the model evolves. This approach can lead to faster and more targeted improvements, as the model always receives feedback on the exact outputs it is most likely to produce at its current parameter state.

Yet because the policy model can produce a large number of candidate responses per query (e.g., 32 or more), storing all these responses and incorporating them into a multi-preference loss function can quickly become computationally prohibitive-both in terms of GPU memory and training time. More importantly, many of these responses may be highly similar or lie in the same “region” of the answer space, leading to redundant gradient signals. The overhead of repeatedly training on such overlapping samples may slow down or bias the learning process rather than enhance it. In addition, the overhead of training on these (often redundant) examples is inefficient, utilizing extra memory, computing cycles, and power.

A useful way to conceptualize this problem is through the metaphor of islands in an “answer space.” Each island represents a cluster or mode of responses that share certain stylistic or semantic features. Some islands might be tall (high reward), others might be flat (low reward), and still others might look deceptively tall but turn out to be mediocre once carefully examined. If the model can only gather finite feedback at a given iteration, it must judiciously decide which islands to “visit.” Focusing solely on the largest or most probable islands might ignore niche but instructive cases; choosing only the tallest and flattest islands might capture extremes at the cost of missing the middle ground.

This situation naturally evokes the lens of active learning, where we “actively” pick the most informative data samples rather than passively take random or exhaustive subsets. By selecting a small yet diverse (or uncertain, or extreme) subset of responses, the model effectively creates a curriculum for itself-learning from the richest signals each epoch. In turn, this leads to sharper updates, reduced computational burden, and improved coverage of different modes of the answer space.

Disclosed in some examples are methods, systems, devices, and machine-readable mediums for optimizing language model training using an Active Multi-Preference Optimization (AMPO) framework through efficient multi-preference alignment while reducing computational overhead, memory usage, power usage, and improving model performance. The methods achieve these benefits by actively selecting the most informative subset of responses from a larger pool of candidate responses using a one-vs-k selection strategy that selects a subset of responses that includes the top scoring response, and a set of k lower ranking responses from the remaining set of responses. The k responses may be selected using one or more of the following strategies: Bottom-K selection that identifies responses with lowest reward scores; Coreset-based selection that applies clustering to group responses based on embedding vectors and selects the lowest-rated response from each cluster; Opt-Select that weights responses by assigning higher weights to responses with lower rewards and selects responses that minimize weighted distances while ensuring semantic distinctness by selecting from different regions of an embedding space that clusters vector representations based upon the weights.

The methods further employ on-policy generation where responses are sampled from the model being optimized, combined with group-contrastive learning techniques that handle both positive examples (highest-rated responses) and negative examples (selected subsets of lower-rated responses), leading to more targeted improvements and better alignment with human preferences. In some examples, the methods utilize a reference-free model approach, whereby the model does not rely on a fixed baseline or reference model and directly optimizes from scalar rewards or scores.

In some examples, the method includes generating N candidate responses for each query using a current policy model, where each response is evaluated using two distinct mechanisms: a reward score is identified or generated using a reward model that assigns quality scores between 0 and 1 to indicate alignment with human preferences, and an embedding model that, in some examples, maps each response to a vector representation to enable measurement of semantic and stylistic similarities between different responses.

The method then employs active selection strategies to identify a subset of K responses (where K is typically much smaller than N, such as K=8 from N=32) that are most informative for training. The present disclosure thus solves the technical problem of expensive processing and memory usage during training of machine-learning models by the technical solution of intelligently selecting the training data to maximize training quality.

Once the K most informative responses are selected, they are used to train the model using SWEPO by being partitioned into positive and negative sets based on their reward scores relative to the local mean reward of the selected subset. These responses are then processed through a group-contrastive loss function that simultaneously optimizes the model's preferences across multiple responses, with each response weighted according to its deviation from the mean reward. This approach allows the model to learn from multiple examples simultaneously while emphasizing responses that are notably better or worse than average.

The method maintains an on-policy learning approach through an iterative update process. After each training iteration, the policy model parameters are updated (e.g., policy parameters θ are updated such as the gradient descent on the SWEPO loss), based on the optimization results, and the previous policy becomes the reference model to ensure stable learning within a trust region. This reference model update ensures that new responses are generated from the most current model state for subsequent iterations, allowing the training process to dynamically adapt to the model's evolving capabilities. The process continues iteratively, with each new generation of responses being actively selected and optimized to further refine the model's alignment with human preferences. In some examples, each epoch of training uses the same selection approaches. In other examples, each epoch may use a different selection approach.

The next section formalizes the components of AMPO and introduces the relevant notation. The objective is to align a policy model to human preferences using multiple, actively chosen responses per query, updated in an on-policy fashion.

Queries and Policy: Let [symbol] ={x₁, x₂, . . . , x_{M}} be a dataset of M queries (or prompts), each drawn from a larger space X. A policy model P_{θ}(y|x) is parameterized by θ, which produces a distribution over possible responses y∈Y. To generate diverse answers, the model P_{θ}(y|x) is sampled at a fixed temperature (e.g., 0.8). Formally, for each xi, up to N responses may be drawn: {y₁, 1, y₂, 2, . . . , yᵢ, N} from P_{θ}(y|x). This is an on-policy sampling that ensures the system provides preference feedback on queries that are chosen by the model.

For simplicity of notation, the following considers a single query (prompt) x and sampled responses {y₁, y₂, . . . , y_{N}} from P_{θ}(⋅|x) from the autoregressive language model. Each response y₁ is assigned a scalar reward: rᵢ=R(x, yᵢ)∈[0,1] where R is a fixed reward function or model (e.g., not optimized during policy training). Each response may be also embedded via e; =ε(yᵢ)∈ [symbol] ^{d} where ε might be any sentence or document encoder capturing semantic or stylistic properties. Training on all N responses may be computationally expensive.

Instead, the system may select a subset S⊂{1, . . . , N} of size |S|=K<N by maximizing a selection criteria (e.g., favoring high rewards, broad coverage in embedding space, or the like). Formally,

$$S ( x ) = arg {{max}_{I ⊂ \{ 1 , … , N \}}}_{\vert I \vert = K} U ( {\{ {y}_{i} \}}_{i ∈ I} , {\{ {r}_{i} \}}_{i ∈ I} , {\{ {e}_{i} \}}_{i ∈ I} )$$

Where U is a utility function tailored to emphasize extremes, diversity, or other alignment needs.

Next, S is split into a positive set S⁺ and a negative set S⁻. For example, let the average reward of the chosen subset be:

$$\overline{r} = \frac{1}{K} {\sum }_{i ∈ S} {r}_{i}$$

And define S⁺={i∈S|rᵢ>r̅}, S⁻={i∈S|rᵢ≤r̅}. Hence S=S⁺∪S⁻ and |S⁺]+|S⁻|=K.

A reference free group-contrastive objective is used to train θ. Concretely, define:

$${L}_{swepo} ( θ ; x ) = - log ( \frac{{\sum }_{y ∈ {Y}^{+}} exp ( {s}_{θ}^{′} ( y \vert x ) )}{{\sum }_{y ∈ {Y}^{+} ⋃ {Y}^{-}} exp ( {s}_{θ}^{′} ( y \vert x ) )} )$$

$$Where$$

$${s}_{θ}^{′} ( y \vert x ) = log {P}_{θ} ( {y}_{i} \vert x ) + α ( {r}_{i} - \overline{r} ) .$$

Here P_{ref} is a reference policy (e.g., an older snapshot of Pe or a baseline model), and a is a hyperparameter scaling the reward difference. SWEPO encourages the model to increase the log-probability of S⁺ while decreasing that of S⁻, all in a single contrastive term that accounts for multiple positives and negatives simultaneously.

Although presented for a single query x, this procedure extends straightforwardly to any dataset D by summing L_{swepo} across all queries. In subsequent sections, diverse strategies for selecting S will be discussed, aiming to maximize training efficiency and alignment quality.

### Example Algorithm and Methodology

In some examples, a one-vs-k selection scheme may be used in which a single best response is promoted (positive), while an active subroutine selects k negative responses from the remaining N−1 candidates. This setup highlights the interplay of three main objectives.
Probability: high-probability responses under P_{θ}(y|x) can dominate even if suboptimal by reward.
Rewards: simply selecting extremes by reward may miss problematic “mediocre” outputs.
Semantics: diverse, but undesired responses in distant embedding regions should be penalized.

While positives reinforce a single high-reward candidate, active negative selection balances probability, reward, and diversity to systematically suppress problematic regions of the response space.

Formally, let {y₁, y₂, . . . , y_{N}} be the sampled responses for a single prompt x. As before, reward function is defined as rt=R(x, yᵢ)∈[0,1], an embedding is defined as eᵢ=ε(yᵢ) and a model probability estimate is defined as πᵢ=P_{θ}(yᵢ|x).

Selection algorithms may be rating-based selection (to identify truly poor or excellent answers) with coverage-based selection (to explore distinct regions in the embedding space), to expose the model to both common and outlier responses. This ensures that the SWEPO loss provides strong gradient signals across the spectrum of answers the model is prone to generating. In the algorithm below, the active selection subroutine is a generic subroutine that selects a set of k “high-impact” negatives. Example implementations for generating these k “high-impact” negatives will be discussed later.

In some examples, the algorithm operates in four steps: First, it selects the highest-reward response as the positive example (lines 3-4). Second, it actively selects k negative examples by considering their rewards, probabilities Ti, and embedding distances eᵢ to capture diverse failure modes (lines 5-7). Third, it constructs the SWEPO objective by computing normalized scores se using the mean reward F and forming a one-vs-k contrastive loss (lines 8-12). Finally, it updates the model parameters to increase the probability of the positive while suppressing the selected negatives (line 13). This approach ensures both reinforcement of high-quality responses and systematic penalization of problematic outputs across the response distribution.
1: Input: (1) A set of N responses {yᵢ} sampled from P_{θ}(y|x); (2) Their rewards {rᵢ}, embeddings {eᵢ}, and probabilities {πᵢ}; (3) Number of negatives k, reference policy P_{ref}, and hyperparameter α
2: Output: (i) Positive y₊; (ii) Negatives {yⱼ}_{j∈S}−; (iii) Updated parameters θ via SWEPO.
3: 1. Select one positive (highest reward)
4: 1₊←arg max_{i-1, . . . , N}rᵢ, y₊←yᵢ_{₊}
5. 2. Choose k negatives via active selection
6: Ω←{1, . . . , N} {i₊}
7: S⁻←ACTIVESELECTION(Ω, {rᵢ}, {eᵢ}, {πᵢ}, k)
8: 3. Form one-vs.-k SWEPO objective

$$9 : \overline{r} ← \frac{{r}_{i} + {\sum }_{j ∈ {S}^{-}} {r}_{j}}{1 + k}$$

10: For each yᵢ:

$$11 : {s}_{θ}^{′} ( {y}_{i} ) = log {P}_{θ} ( {y}_{i} \vert x ) + α ( {r}_{i} - \overline{r} )$$

$$12 : {L}_{swepo} ( θ ) = - log ( \frac{exp ( {s}_{θ}^{′} ( {y}_{+} ) )}{exp ( {s}_{θ}^{′} ( {y}_{+} ) ) + {\sum }_{j ∈ S} - exp ( {s}_{θ}^{′} ( {y}_{j} ) )} )$$

13: 4. Update model parameters: θ←θ−η∇_{θ}L_{swepo}(θ)
14: return The chosen positive y₊, the negative set {yⱼ}_{j∈S}−, and the updated parameters θ.

### Active Subset Selection Strategies

Two strategies for actively selecting a small set of negative responses in the AMPO framework are now detailed. The first strategy, called, AMPO-BottomK, directly picks the lowest rated responses. Second, AMPO-Coreset will be described which is a clustering-based method that selects exactly one negative from each cluster in the embedding space, thereby achieving broad coverage of semantically distinct regions.

### AMPO-BottomK

The AMPO-BottomK is a direct approach that is used for comparison: given N sampled responses and their scalar ratings

$${\{ {r}_{i} \}}_{i = 1}^{N} ,$$

the k lowest-rated responses are picked as negatives. This can be expressed as: S⁻=argtopkᵢ(−rᵢ, k), which identifies the k indices with smallest rᵢ. This method may be quite effective when the reward function reliably indicates “bad” behavior. Furthermore, to break-ties, a minimal cosine similarity with the currently selected set may be used.

### AMPO-Coreset (Clustering-Based Selection)

AMPO-BottomK may overlook problematic modes that are slightly better than the bottom-k, but fairly important to learn on. A diversity-driven approach, which is referred to herein as AMPO-CORESET, explicitly seeks coverage in the embedding space by partitioning the N candidate responses into k clusters and then selecting the lowest-rated response within each cluster. Formally:

$${i}_{j}^{-} = arg {min}_{i ∈ {C}_{j}} {r}_{i} , j = 1 , … , k , {S}^{-} = \{ {i}_{i}^{-} , … , {i}_{k}^{-} \}$$

Where Cⱼ is the set of responses assigned to cluster j by a k-means algorithm. This approach enforces that each cluster-a potential “mode” in the response space-contributes at least one negative example. Hence, AMPO-Coreset can be interpreted as selecting representative negatives from diverse semantic regions, ensuring that the model is penalized for a wide variety of undesired responses. An example pseudocode is shown below:
1: Input:
2: (1) N responses, each with embedding eᵢ∈ [symbol] ^{d} and rating rᵢ
3: (2) desired number of negatives k
4:
5: Step 1: Run k-means on the embeddings
6: Initialize {c₁, . . . , cₖ}⊂ [symbol] ^{d} (e.g., via k-means++)
7: repeat
8: π(i)=argmin_{1≤j≤k}∥eᵢ−cⱼ∥², i=1, . . . , N

$$9 : {C}_{j} = \frac{{\sum }_{i : π ( i ) = j} {e}_{i}}{{\sum }_{i : π ( i ) = j} 1} , j = 1 , … , k$$

10: until convergence
11:
12: Step 2: In each cluster, pick the bottom-rated response
13: For each j∈{1, . . . , k}, define Cⱼ={i|π(i)=j}

$$14 : Then {i}_{j}^{-} = {argmin}_{i ∈ C} {r}_{i} , j = 1 , … , k$$

15:
16: Step 3: return negatives

$$17 : {S}^{-} = \{ {i}_{1}^{-} , {i}_{2}^{-} , … , {i}_{k}^{-} \}$$

18: return S⁻ as the set of k negatives

### Opt-Select: Active Subset Selection by Optimizing Expected Reward

In some examples, Opt-Select chooses k negative responses (plus one positive) so as to maximize the policy's expected reward under a Lipschitz continuity assumption. Specifically the local “neighborhood” influence of penalizing each selected negative is modelled and an optimization problem is formulated that seeks to suppress large pockets of low-reward answers while preserving at least one high-reward mode. The intuition and objective are first described, and then two solution methods are presented: a mixed-integer program (MIP) and a local search approximation.

### Lipschitz-Driven Objective

Let

$${\{ {y}_{i} \}}_{i = 1}^{n}$$

be candidate responses sampled on-policy, each with reward rᵢ∈ [symbol] ^{d}. If a response yⱼ is completely suppressed (i.e., set its probability to zero), all answers within distance ∥eᵢ−eⱼ∥ must also decrease in probability proportionally, due to a Lipschitz constraint on the policy. Concretely, if the distance is d_{i,j}=∥eᵢ−eⱼ∥, and the model's Lipschitz constant is L, then the probability of yᵢ cannot remain above Ld_{i,j} if yᵢ is forced to probability zero.

From an expected reward perspective, assigning zero probability to low-reward responses (and their neighborhoods) improves overall alignment. To capture this rigorously, observe that the penalty from retaining a below-average answer y; can be weighted by: wᵢ=exp(r̅−rᵢ), where r̅ is (for instance) the mean reward of {rᵢ}. Intuitively, wᵢ is larger for lower-reward yᵢ, indicating it is more harmful to let yᵢ and its neighborhood remain at high probability.

Next, define a distance matrix:

A_{i,j}=∥eᵢ−eⱼ∥₂, 1≤i,j≤n.

Selecting a subset S⊆{1, . . . , n} of “negatives” to penalize suppresses the probability of each i in proportion to min_{j∈S}A_{i,j}. Consequently, a nature cost function measures how much “weighted distance” yᵢ has to its closest chosen negative:

$$Cost ( S ) = {\sum }_{i = 1}^{n} {w}_{i} {min}_{j ∈ S} {A}_{i , j} .$$

Minimizing the above equation yields a subset S of size k that coverse or suppresses as many low-reward responses (large wᵢ) as possible. One positive index top is then added with the highest rᵢ to amplify a top-quality answer. This combination of one positive plus k negatives provides a strong signal in the training loss.

Interpretation and Connection to Weighted k-Medoids

If each negative j covers responses i within some radius (or cost) A_{i,j} then the Cost(S) equation is analogous to a weighted k-medoid objective where k items (negatives) are chosen to minimize a total weighted distance. Formally this can be cast as a mixed integer program (MIP) (discussed below). For large n, local search offers an efficient approximation.

### Mixed Integer Programming Formulation

Define binary indicators xⱼ=1 if we chose yⱼ as a negative, and z_{i,j}=1 if I is assigned to j (i.e., min_{j∈S}A_{i,j} is realized by j).

### Problem P:

$${min}_{{x}_{j} ∈ \{ 0 , 1 \} , {z}_{i , j} ∈ \{ 0 , 1 \} , {y}_{i} \geq 0} {\sum }_{i = 1}^{n} {w}_{i} {y}_{i}$$

$$s . t . {\sum }_{j = 1}^{n} {x}_{j} = k , {z}_{i , j} \leq {x}_{j} , {\sum }_{j = 1}^{n} {z}_{i , j} = 1 , ∀ i ,$$

$${y}_{i} \leq {A}_{i , j} + M ( 1 - {z}_{i , j} ) ,$$

$${y}_{i} \leq {A}_{i , j} - M ( 1 - {z}_{i , j} ) , ∀ i , j$$

Where M=max_{i,j}A_{i,j}. In essence, each i is forced to assign to exactly one chosen negative j, making yᵢ=A_{i,j}, i.e., the distance between the answer embeddings for answer {i,j}. Minimizing Σᵢwᵢyᵢ (i.e., from the Cost(S) equation) then ensures that low-reward points (wᵢ large) lie close to at least one penalized center.

Algorithmic Overview. Solving P gives the k negatives S_{neg}, while the highest-reward index iₜₒₚ may be chosen as a positive. The final subset {iₜₒₚ}∪S_{neg} is then passed to the SWEPO loss function.

### Local Search Approximation

For large n, an exact MIP may be expensive. A simpler local search approach initializes a random subset S of size k and iteratively swaps elements in and out if it lowers the cost equation. In practice this provides an efficient approximation, especially when n or k grows.

### Example Pseudocode for AMPO-OPTSELECT Via Solving MIP

1: Input: Candidates

$${\{ {y}_{i} \}}_{i = 1}^{n}$$

with rᵢ, eᵢ; integer k
2: Compute: iₜₒₚ=argmaxᵢrᵢ
3: Let wi=exp (r̅−rᵢ) with r̅ as mean reward
4: Solve Problem P equation to get

$$\{ {x}_{j}^{*} \} , \{ {z}_{i , j}^{*} \} , \{ {y}_{i}^{*} \} :$$

$${min}_{{x}_{j} ∈ \{ 0 , 1 \} , {z}_{i , j} ∈ \{ 0 , 1 \} , {y}_{i} \geq 0} {\sum }_{i = 1}^{n} {w}_{i} {y}_{i}$$

$$5 : Let {S}_{neg} = \{ j \vert {x}_{j}^{*} = 1 \} ( size k )$$

6: return {iₜₒₚ}∪S_{neg} for SWEPO training.

### Example Pseudocode for AMPO-OPTSELECT Via Coordinate Descent

1: Set I={1, . . . , n}, integer k, distances A_{i,j}, rewards {rᵢ}
2: Find iₜₒₚ=arg maxᵢrᵢ
3: Compute wᵢ=exp(r̅−rᵢ) and d_{i,j}=A_{i,j}
4: Initialize a random subset S⊂I{iₜₒₚ} of size k
5. While improving do
6; Swap jₒᵤₜ∈S with jᵢₙ∉S if it decreases
   Σ_{i∈I}_{^{w}}ᵢmin_{j∈S}d_{i,j}
7: end while
8: return S_{neg}=S (negatives) and iₜₒₚ(positive)

### Intuition

If yᵢ is far from all penalized points j∈S, then it remains relatively safe from suppression, which is undesirable if rᵢ is low (i.e., if wᵢ is large). By systematically choosing S to reduce

$${\sum }_{i} {w}_{i} {min}_{j ∈ S} {d}_{i , j} ,$$

high-impact, low reward regions are penalized. The local search repeatedly swaps elements until no single exchange can further reduce the cost.

In some examples, solving the equation:

$${min}_{{x}_{j} ∈ \{ 0 , 1 \} , {z}_{i , j} ∈ \{ 0 , 1 \} , {y}_{i} \geq 0} {\sum }_{i = 1}^{n} {w}_{i} {y}_{i}$$

$$s . t . {\sum }_{j = 1}^{n} {x}_{j} = k , {z}_{i , j} \leq {x}_{j} , {\sum }_{j = 1}^{n} {z}_{i , j} = 1 , ∀ i ,$$

Directly approximates an optimal subset for improving the policy's expected reward. Specifically under a Lipschitz constraint with constant L, assigning zero probability to each chosen negative yⱼ implies neighboring answers yᵢ at distance d_{i,j} cannot exceed probability Ld_{i,j}. Consequently, their contribution to the bad behavior portion of expected reward is bounded by:

exp(rₘₐₓ−rᵢ)(Ld_{i,j}),
Where rₘₐₓ is the rating of the best-rated response. Dividing by a normalization factor (such as (exp (rₘₐₓ−r̅)L), a cost akin to wᵢd_{i,j}, with wᵢ=exp (r̅−rᵢ) is arrived at. This aligns with classical min-knapsack of minimizing some costs subject to some constraints, and has close alignment with the weighted k-medoid notions of “covering” important items at minimum cost.

### Why “Opt-Select”? A Lipschitz Argument for Expected Reward

The procedure is named “Opt-Select” because solving

$${min}_{{x}_{j} ∈ \{ 0 , 1 \} , {z}_{i , j} ∈ \{ 0 , 1 \} , {y}_{i} \geq 0} {\sum }_{i = 1}^{n} {w}_{i} {y}_{i}$$

(or its local search variant) directly approximates an optimal subset for improving the policy's expected reward. Specifically, under a Lipschitz constraint with constant L, assigning zero probability to each chosen negative yⱼ implies neighboring answers y; at distance d_{i,j} cannot exceed probability L d_{i,j}. Consequently, their contribution to the “bad behavior” portion of the expected reward is bounded by: exp(rₘₐₓ−rᵢ) (L d_{i,j}), Where “max is the rating of the best-rated response. Dividing by a normalization factor (such as exp (rₘₐₓ−r̅) L), one arrives at a cost akin to wᵢd_{i,j} with wᵢ=exp(r̅−rᵢ). This aligns with classical min-knapsack of minimizing some costs subject to some constraints, and has close alignment with weighted k-medoid notions of covering important items at minimum cost.

### Iterating Over Multiple Epochs

All of the above strategies can be re-applied at each epoch as the policy model itself changes. Once the policy model is updated, a fresh set of N responses is generated under the new policy, and the N responses are re-scored with the reward model. In some examples, the embeddings may be recomputed. This ensures that each round of active selection is on-policy: the data distribution reflects the model's current parameters, and the most critical or instructive samples may be prioritized to further refine the model. Unlike a fixed offline procedure, re-running active selection at each iteration adapts to the evolving behavior of the policy, reinforcing beneficial shifts and exposing newly emerging mistakes.

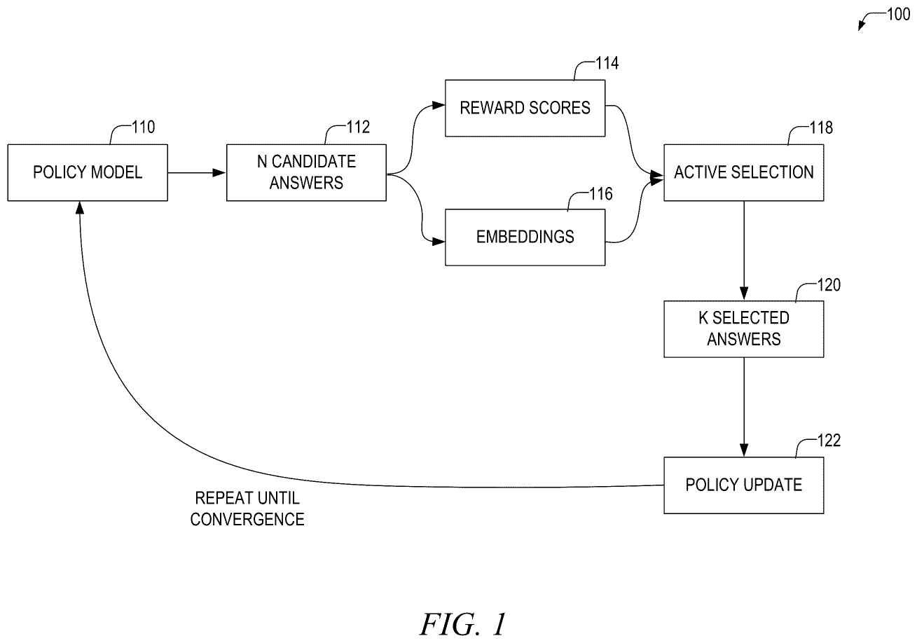

FIG. 1 illustrates a schematic showing the iterative nature of AMPO according to some examples of the present disclosure. At iteration t, the policy model 110 is used to generate N candidate responses 112 for each query x in the training set. Next, scalar reward scores 114 in [0,1] are assigned to each response (e.g., using a reward model). A sentence embedder ε(⋅) maps each response to a vector in [symbol] ^{d} to create embeddings 116, enabling distance-based measures of diversity. The reward scores 114 and embeddings 116 are used by active selection 118 to select a subset of the N candidate responses 112. The active selection 118 uses one or more of the subset selection algorithms discussed previously to pick K out of N candidate response. In some examples, the subset selection algorithm picks the most informative K out of N response. The K-selected answers 120 are then used to apply a group-contrastive loss algorithm (e.g., SWEPO) to the K-selected answers, by weighting the answers by their deviation from the mean reward. After each epoch, the policy parameters θ are updated 122 (e.g., gradient descent on the SWEPO loss). The old policy is then promoted to be the reference model, ensuring that the trust-region style regime is maintained. With the updated policy, the system repeats until convergence. This iterative loop constitutes an on-policy adaption, as each new policy rollout changes the distribution of sampled responses.

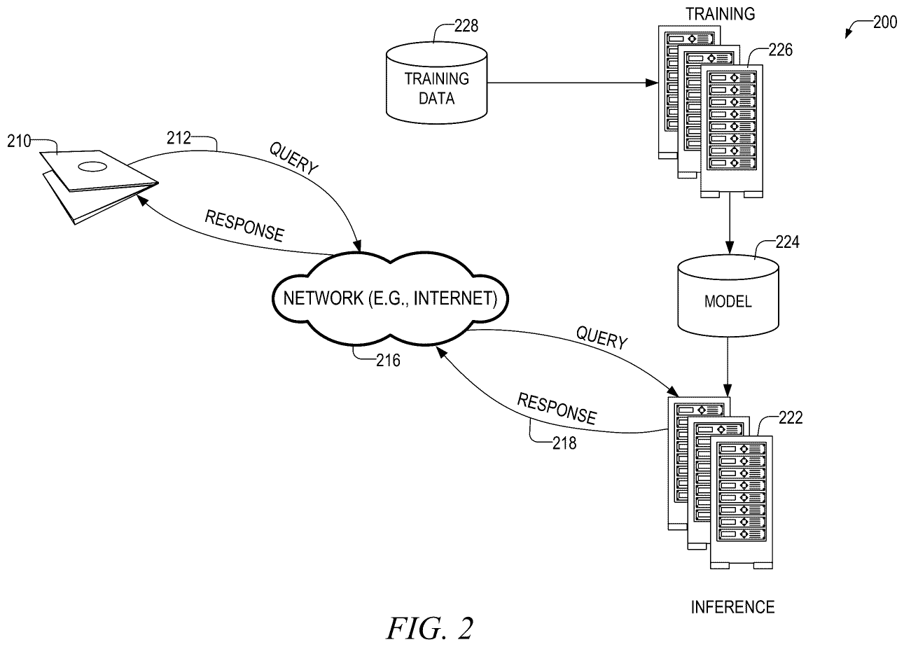

FIG. 2 shows a machine-learning model system 200 according to some examples of the present disclosure. The system 200 includes a user computing device 210, which is configured to send a query 212 over a network 216, such as the Internet. The network 216 facilitates communication between the user computing device 210 and an inference service 222, which processes the query 212 and generates a response 218. This response 218 is then transmitted back to the user computing device 210. In some examples, the query 212 may be a prompt and the response 218 may be text, images, videos, or the like. In some examples the inference service 222 executes on one or more server computing devices.

The inference services 222 uses a model 224 to generate the response 218 from the query 212. For example, the model 224 may be a generative Artificial Intelligence model such as a language model. Example language models may include large language models (LLMs). The model 224 is trained using a training service 226, which utilizes training data 228 to create model 224. In some examples, this process involves learning weights and biases of neurons within a neural network. In some examples, the training service 226 may utilize the SWEPO method disclosed herein. In some examples the training service 226 executes on one or more server computing devices.

In some examples, the training service 226 and the inference service 222 may be implemented on the same computing system. This configuration allows for seamless integration between training and inference processes, enabling real-time updates to the model 224 as new training data 228 becomes available. By sharing computational resources, this setup can reduce latency and improve the efficiency of model updates, ensuring that the model 224 remains current and responsive to evolving data patterns and user queries.

Alternatively, the training service 226 and the inference service 222 may be deployed on separate computing systems. This separation can be advantageous in scenarios where the training process requires significant computational power and resources, which may not be feasible to maintain on the same system as the inference component. By distributing the workload across different systems, organizations can optimize resource allocation, ensuring that both training and inference processes operate efficiently. This configuration also allows for greater flexibility in scaling each component independently, accommodating varying demands for training and inference tasks.

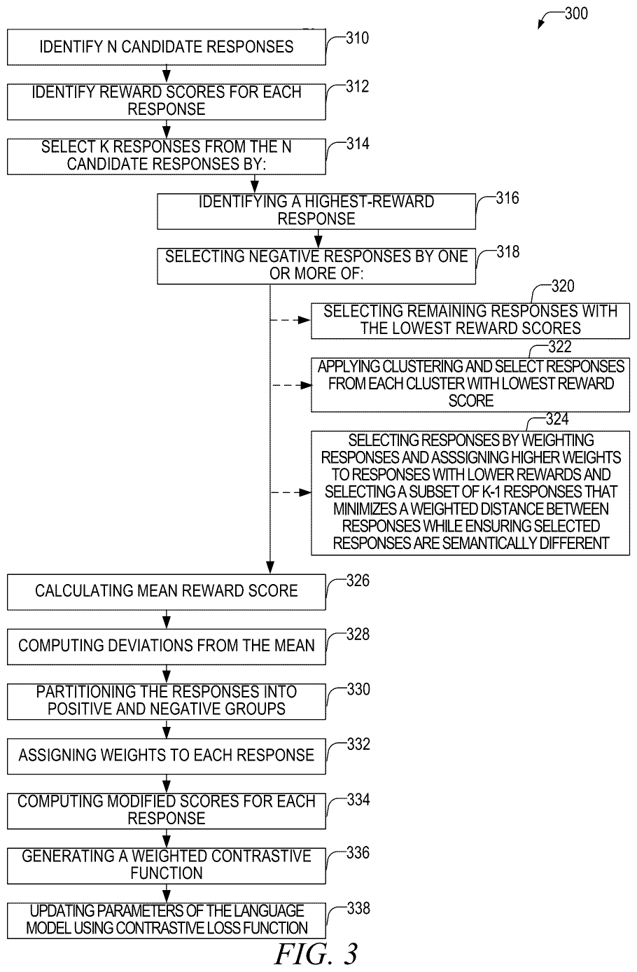

FIG. 3 shows a flowchart of a method for Active Multi-Preference Optimization, which is designed to enhance the training of language models by efficiently selecting and utilizing candidate responses, according to some examples of the present disclosure. At operation 310, the process begins with identifying N candidate responses 112 for a given input query. This step may involve generating a diverse set of potential responses that the language model can produce, ensuring a broad spectrum of possibilities is considered. For example, the candidate responses may be generated by a generative AI model, such as a LLM. The model used to generate the candidate responses may be the model being optimized by the method 300 (e.g., the policy model). In some examples, the responses may be generated using stochastic sampling from the same language model being optimized. At operation 312, reward scores are identified for each of the N candidate responses 112. These scores may be derived from a reward model that evaluates how well each response aligns with predefined human preferences, providing a quantitative measure of quality for each response.

At operation 314, the method selects K responses from the N candidate responses 112. This selection process narrows down the responses to a manageable subset that will be used for further optimization. The selection is performed by first identifying a response with the greatest reward at operation 316, which serves as a positive example in the optimization process.

Operation 318 focuses on selecting negative responses by employing one or more strategies. These strategies include selecting remaining responses with minimal reward scores at operation 320, applying clustering to group responses based on embedding vectors and selecting a response from each cluster with minimal reward score at operation 322, and selecting responses by weighting them and assigning higher weights to those with lower rewards. This latter strategy, detailed in operation 324, involves selecting a subset of K−1 responses that minimizes a weighted distance between responses while ensuring the selected responses are semantically distinct.

Once the K responses are selected, operation 326 calculates the mean reward score from the reward scores of these responses. This mean score serves as a benchmark for evaluating the deviations of individual responses.

Operation 328 involves computing deviations of each selected response's reward score from the mean reward score. These deviations are used to partition the responses into positive and negative groups at operation 330, where responses with deviations above the mean are assigned to the positive group, and those with deviations below or equal to the mean are assigned to the negative group.

At operation 332, weights are assigned to each response based on the response's deviation from the mean reward score. Responses with larger deviations from the mean are assigned higher weights, emphasizing their importance in the optimization process. At operation 334, the system computes modified scores for each response by combining a base score with the assigned weight. These modified scores are used to generate a weighted contrastive function at operation 336, which forms the basis for updating the language model's parameters using a contrastive loss function. At operation 338, the system updates the parameters of the language model using the contrastive loss function derived from the weighted contrastive function. This update process refines the model's ability to generate responses that align more closely with human preferences, thereby enhancing the model's overall performance and alignment capabilities. FIG. 3 may be repeated over a number of epochs, with the newly refined model being used to generate the training data set for the next epoch.

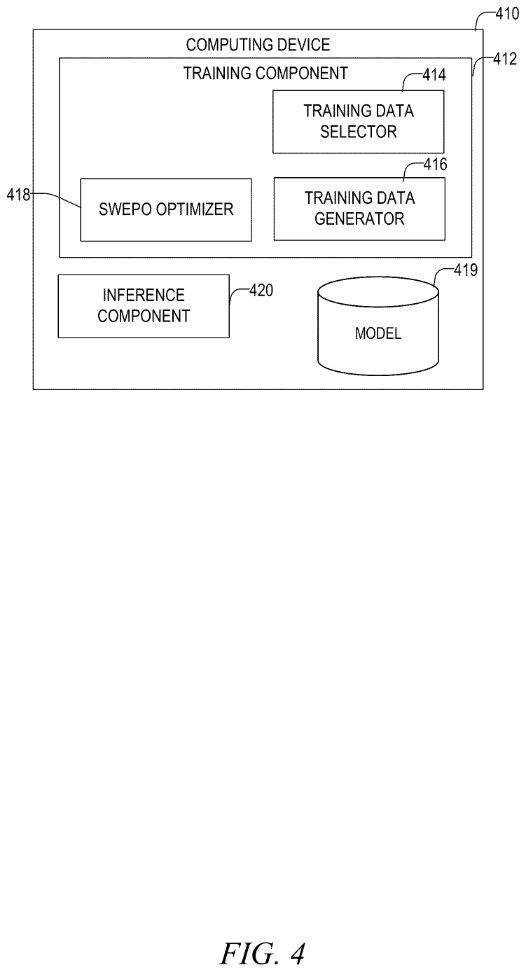

FIG. 4 shows a computing device 410 that incorporates a training component 412 and an inference component 420 according to some examples of the present disclosure. The computing device 410 is designed to facilitate the training and inference processes for machine learning models, providing an environment for model development and deployment.

The training component 412 may be utilized to prepare and optimizing the machine learning models, such as model 419. Within the training component 412, the training data generator 416 may generate training data. For example, by using the model 419 to generate “on-policy” training data. Training data may comprise a series of queries having a plurality of responses. The training component 412 may also identify or otherwise calculate a reward, such as from a reward model—which may be the model 419 or may be a separately trained reward model that is trained to score responses based upon human preferences.

A training data selector 414 may take the set of training data produced by the training data generator 416 and select the most relevant and informative data subsets from a larger dataset. This selection process ensures that the model is trained on data that enhances learning efficiency and model performance. The selection process involves choosing K responses from the N candidates, where K is smaller than N. This is achieved through a multi-step approach:
Positive Example Selection: The highest-reward response is identified and selected as a positive example. This response serves as a benchmark for the desired quality level in the training data.
Negative Response Selection: The selector employs various strategies to choose K−1 negative responses from the remaining candidates. These strategies include bottom-k selection, coreset, and opt-select strategies as previously described.

The SWEPO optimizer 418 implements the Simultaneous Weighted Preference Optimization (SWEPO) method using the filtered training data from the training data selector 414. The SWEPO optimizer 418 optimizes the model's parameters by considering multiple preferences at the same time. This optimizer is designed to reduce alignment bias and improve how well the model aligns with human preferences, thereby enhancing the overall quality of the model's outputs. In some examples, the model may be trained over multiple epochs, repeating the training data generation and selection as well as the inference component.

The inference component 420 is responsible for deploying the trained model to perform predictions or generate responses based on new input data. This component ensures that the model can be used in real-time applications, providing quick and accurate results. The model is subsequently stored within the computing device 410, ready to be utilized by the inference component 420.

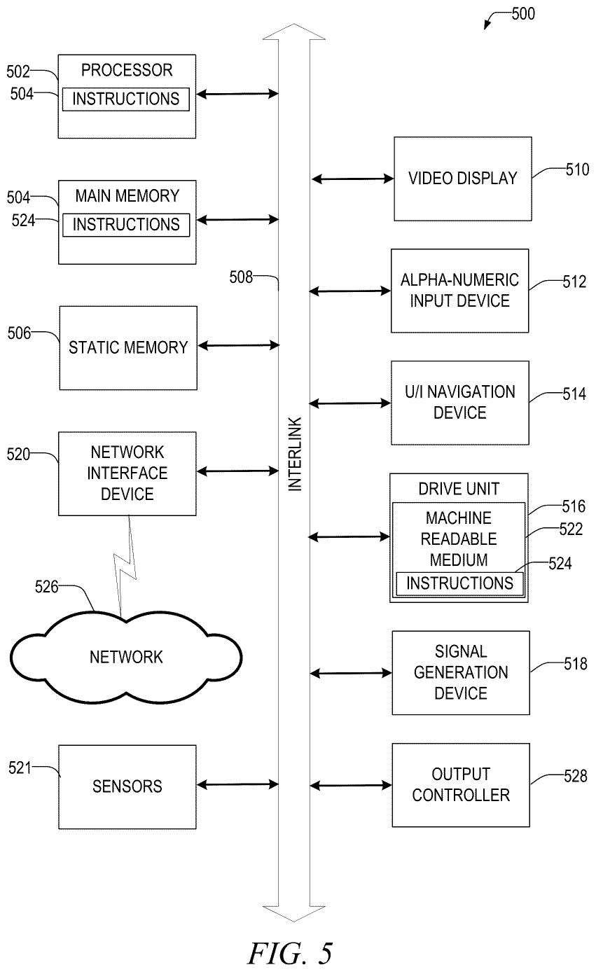

FIG. 5 illustrates a block diagram of an example machine 500 upon which any one or more of the techniques (e.g., methodologies) discussed herein may be performed. In alternative embodiments, the machine 500 may operate as a standalone device or may be connected (e.g., networked) to other machines. In a networked deployment, the machine 500 may operate in the capacity of a server machine, a client machine, or both in server-client network environments. In an example, the machine 500 may act as a peer machine in peer-to-peer (P2P) (or other distributed) network environment. The machine 500 may be in the form of a server, personal computer (PC), a tablet PC, a set-top box (STB), a personal digital assistant (PDA), a mobile telephone, a smart phone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations. Machine 500 may be configured to implement, alone or in combination with other machines, the process of FIG. 1, one or more of the components of FIG. 2, the method of FIG. 3, and the components of FIG. 4.

Examples, as described herein, may include, or may operate on one or more logic units, components, or mechanisms (hereinafter “components”). Components are tangible entities (e.g., hardware) capable of performing specified operations and may be configured or arranged in a certain manner. In an example, circuits may be arranged (e.g., internally or with respect to external entities such as other circuits) in a specified manner as a component. In an example, the whole or part of one or more computer systems (e.g., a standalone, client or server computer system) or one or more hardware processors may be configured by firmware or software (e.g., instructions, an application portion, or an application) as a component that operates to perform specified operations. In an example, the software may reside on a machine readable medium. In an example, the software, when executed by the underlying hardware of the component, causes the hardware to perform the specified operations of the component.

Accordingly, the term “component” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which component are temporarily configured, each of the components need not be instantiated at any one moment in time. For example, where the components comprise a general-purpose hardware processor configured using software, the general-purpose hardware processor may be configured as respective different components at different times. Software may accordingly configure a hardware processor, for example, to constitute a particular module at one instance of time and to constitute a different component at a different instance of time.

Machine (e.g., computer system) 500 may include one or more hardware processors, such as processor 502. Processor 502 may be a central processing unit (CPU), a graphics processing unit (GPU), a hardware processor core, or any combination thereof. Machine 500 may include a main memory 504 and a static memory 506, some or all of which may communicate with each other via an interlink (e.g., bus) 508. Examples of main memory 504 may include Synchronous Dynamic Random-Access Memory (SDRAM), such as Double Data Rate memory, such as DDR4 or DDR5. Interlink 508 may be one or more different types of interlinks such that one or more components may be connected using a first type of interlink and one or more components may be connected using a second type of interlink. Example interlinks may include a memory bus, a peripheral component interconnect (PCI), a peripheral component interconnect express (PCIe) bus, a universal serial bus (USB), or the like.

The machine 500 may further include a display unit 510, an alphanumeric input device 512 (e.g., a keyboard), and a user interface (UI) navigation device 514 (e.g., a mouse). In an example, the display unit 510, input device 512 and UI navigation device 514 may be a touch screen display. The machine 500 may additionally include a storage device (e.g., drive unit) 516, a signal generation device 518 (e.g., a speaker), a network interface device 520, and one or more sensors 521, such as a global positioning system (GPS) sensor, compass, accelerometer, or other sensor. The machine 500 may include an output controller 528, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 516 may include a machine readable medium 522 on which is stored one or more sets of data structures or instructions 524 (e.g., software) embodying or utilized by any one or more of the techniques or functions described herein. The instructions 524 may also reside, completely or at least partially, within the main memory 504, within static memory 506, or within the hardware processor 502 during execution thereof by the machine 500. In an example, one or any combination of the hardware processor 502, the main memory 504, the static memory 506, or the storage device 516 may constitute machine readable media.

While the machine readable medium 522 is illustrated as a single medium, the term “machine readable medium” may include a single medium or multiple media (e.g., a centralized or distributed database, and/or associated caches and servers) configured to store the one or more instructions 524.

The term “machine readable medium” may include any medium that is capable of storing, encoding, or carrying instructions for execution by the machine 500 and that cause the machine 500 to perform any one or more of the techniques of the present disclosure, or that is capable of storing, encoding or carrying data structures used by or associated with such instructions. Non-limiting machine readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); Solid State Drives (SSD); and CD-ROM and DVD-ROM disks. In some examples, machine readable media may include non-transitory machine readable media. In some examples, machine readable media may include machine readable media that is not a transitory propagating signal.

The instructions 524 may further be transmitted or received over a communications network 526 using a transmission medium via the network interface device 520. The Machine 500 may communicate with one or more other machines wired or wirelessly utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks such as an Institute of Electrical and Electronics Engineers (IEEE) 802.11 family of standards known as Wi-Fi®, an IEEE 802.15.4 family of standards, a 5G New Radio (NR) family of standards, a Long Term Evolution (LTE) family of standards, a Universal Mobile Telecommunications System (UMTS) family of standards, peer-to-peer (P2P) networks, among others. In an example, the network interface device 520 may include one or more physical jacks (e.g., Ethernet, coaxial, or phone jacks) or one or more antennas to connect to the communications network 526. In an example, the network interface device 520 may include a plurality of antennas to wirelessly communicate using at least one of single-input multiple-output (SIMO), multiple-input multiple-output (MIMO), or multiple-input single-output (MISO) techniques. In some examples, the network interface device 520 may wirelessly communicate using Multiple User MIMO techniques.

### OTHER NOTES AND EXAMPLES

Example 1 is a computer-implemented method for training a language model, comprising: identifying N candidate responses for an input query; identifying reward scores for each of the N candidate responses; selecting K responses from the N candidate responses, where K is less than N by: identifying a highest-reward response as a positive example; and selecting K−1 negative responses from remaining responses by one or more of: selecting remaining responses with the lowest reward scores; applying clustering to group the remaining responses based on corresponding embedding vectors and selecting a response from each cluster with a lowest reward score; or selecting responses by weighting responses and assigning higher weights to responses with lower rewards, and selecting a subset of K−1 responses that minimizes weighted distances between responses while ensuring selected responses are semantically distinct from each other by selecting responses from different regions of an embedding space that clusters vector representations corresponding to the remaining responses based upon the weights; calculating a mean reward score from the reward scores of the K selected responses; computing deviations of each selected response's reward score from the mean reward score; partitioning the K selected responses into positive and negative groups by assigning responses with deviations above the mean reward score to the positive group, and assigning responses with deviations below or equal to the mean reward score to the negative group; assigning weights to each response based on its deviation from the mean reward score, wherein: responses with larger absolute deviations from the mean reward score are assigned higher weights than responses with smaller absolute deviations; computing modified scores for each response by combining a base score with the assigned weight; generating a weighted contrastive loss function based on the modified scores of the responses in the positive and negative groups; and updating parameters of the language model by optimizing the weighted contrastive loss function.

In Example 2, the subject matter of Example 1 includes, wherein selecting K responses further comprises: computing embedding vectors for each of the N candidate responses using a sentence encoder model.

In Example 3, the subject matter of Examples 1-2 includes, wherein applying clustering comprises applying K-means clustering.

In Example 4, the subject matter of Examples 1-3 includes, wherein assigning weights to each response comprises: calculating absolute deviations from the mean reward score; and applying a scaling factor a to control influence of the deviations on final weights.

In Example 5, the subject matter of Examples 1~4 includes, wherein the reward scores are calculated using a reward model that is a pre-trained model that scores each response based upon an alignment with human preferences.

In Example 6, the subject matter of Examples 1-5 includes, wherein identifying N candidate responses for an input query comprises using the language model to generate the N candidate response.

In Example 7, the subject matter of Examples 1-6 includes, wherein selecting responses by optimizing coverage of low-reward regions while maximizing pairwise distances between embedding vectors comprises: computing weights for each response that are inversely proportional to the response's reward score, such that responses with lower rewards receive higher weights; calculating pairwise distances between embedding vectors in the embedding space to measure semantic similarity between responses; selecting a subset of K−1 responses by: identifying clusters of semantically similar responses based on their embedding vector distances; choosing responses from different clusters to maximize semantic diversity; prioritizing responses with higher weights within each cluster to emphasize coverage of low-reward regions; and verifying that selected responses maintain minimum pairwise distances in the embedding space to ensure semantic distinctness.

Example 8 is a computing device for training a language model, the computing device comprising: a hardware processor; a memory, the memory storing instructions, which when executed by the hardware processor cause the computing device to perform operations comprising: identifying N candidate responses for an input query; identifying reward scores for each of the N candidate responses; selecting K responses from the N candidate responses, where K is less than N by: identifying a highest-reward response as a positive example; and selecting K−1 negative responses from remaining responses by one or more of: selecting remaining responses with the lowest reward scores; applying clustering to group the remaining responses based on corresponding embedding vectors and selecting a response from each cluster with a lowest reward score; or selecting responses by weighting responses and assigning higher weights to responses with lower rewards, and selecting a subset of K−1 responses that minimizes weighted distances between responses while ensuring selected responses are semantically distinct from each other by selecting responses from different regions of an embedding space that clusters vector representations corresponding to the remaining responses based upon the weights; calculating a mean reward score from the reward scores of the K selected responses; computing deviations of each selected response's reward score from the mean reward score; partitioning the K selected responses into positive and negative groups by assigning responses with deviations above the mean reward score to the positive group, and assigning responses with deviations below or equal to the mean reward score to the negative group; assigning weights to each response based on its deviation from the mean reward score, wherein: responses with larger absolute deviations from the mean reward score are assigned higher weights than responses with smaller absolute deviations; computing modified scores for each response by combining a base score with the assigned weight; generating a weighted contrastive loss function based on the modified scores of the responses in the positive and negative groups; and updating parameters of the language model by optimizing the weighted contrastive loss function.

In Example 9, the subject matter of Example 8 includes, wherein the operations further comprise: computing embedding vectors for each of the N candidate responses using a sentence encoder model.

In Example 10, the subject matter of Examples 8-9 includes, wherein the operation of applying clustering further comprises applying K-means clustering.

In Example 11, the subject matter of Examples 8-10 includes, wherein the operation of assigning weights to each response further comprises: calculating absolute deviations from the mean reward score; and applying a scaling factor aa to control influence of the deviations on final weights.

In Example 12, the subject matter of Examples 8-11 includes, wherein the reward scores are calculated using a reward model that is a pre-trained model that scores each response based upon an alignment with human preferences.

In Example 13, the subject matter of Examples 8-12 includes, wherein the operation of identifying N candidate responses for an input query further comprises using the language model to generate the N candidate responses.

In II Example 14, the subject matter of Examples 8-13 includes, wherein the operation of selecting responses by optimizing coverage of low-reward regions while maximizing pairwise distances between embedding vectors further comprises: computing weights for each response that are inversely proportional to the response's reward score, such that responses with lower rewards receive higher weights; calculating pairwise distances between embedding vectors in the embedding space to measure semantic similarity between responses; selecting a subset of K−1 responses by: identifying clusters of semantically similar responses based on their embedding vector distances; choosing responses from different clusters to maximize semantic diversity; prioritizing responses with higher weights within each cluster to emphasize coverage of low-reward regions; and verifying that selected responses maintain minimum pairwise distances in the embedding space to ensure semantic distinctness.

Example 15 is a non-transitory machine-readable medium, storing instructions for training a language model, the instructions, which when executed, cause the machine to perform operations comprising: identifying N candidate responses for an input query; identifying reward scores for each of the N candidate responses; selecting K responses from the N candidate responses, where K is less than N by: identifying a highest-reward response as a positive example; and selecting K−1 negative responses from remaining responses by one or more of: selecting remaining responses with the lowest reward scores; applying clustering to group the remaining responses based on corresponding embedding vectors and selecting a response from each cluster with a lowest reward score; or selecting responses by weighting responses and assigning higher weights to responses with lower rewards, and selecting a subset of K−1 responses that minimizes weighted distances between responses while ensuring selected responses are semantically distinct from each other by selecting responses from different regions of an embedding space that clusters vector representations corresponding to the remaining responses based upon the weights; calculating a mean reward score from the reward scores of the K selected responses; computing deviations of each selected response's reward score from the mean reward score; partitioning the K selected responses into positive and negative groups by assigning responses with deviations above the mean reward score to the positive group, and assigning responses with deviations below or equal to the mean reward score to the negative group; assigning weights to each response based on its deviation from the mean reward score, wherein: responses with larger absolute deviations from the mean reward score are assigned higher weights than responses with smaller absolute deviations; computing modified scores for each response by combining a base score with the assigned weight; generating a weighted contrastive loss function based on the modified scores of the responses in the positive and negative groups; and updating parameters of the language model by optimizing the weighted contrastive loss function.

In Example 16, the subject matter of Example 15 includes, wherein the operations further comprise: computing embedding vectors for each of the N candidate responses using a sentence encoder model.

In Example 17, the subject matter of Examples 15-16 includes, wherein the operation of applying clustering further comprises applying K-means clustering.

In Example 18, the subject matter of Examples 15-17 includes, wherein the operation of assigning weights to each response further comprises: calculating absolute deviations from the mean reward score; and applying a scaling factor aa to control influence of the deviations on final weights.

In Example 19, the subject matter of Examples 15-18 includes, wherein the reward scores are calculated using a reward model that is a pre-trained model that scores each response based upon an alignment with human preferences.

In Example 20, the subject matter of Examples 15-19 includes, wherein the operation of identifying NN candidate responses for an input query further comprises using the language model to generate the NN candidate responses.

In Example 21, the subject matter of Examples 15-20 includes, wherein the operation of selecting responses by optimizing coverage of low-reward regions while maximizing pairwise distances between embedding vectors further comprises: computing weights for each response that are inversely proportional to the response's reward score, such that responses with lower rewards receive higher weights; calculating pairwise distances between embedding vectors in the embedding space to measure semantic similarity between responses; selecting a subset of K−1K−1 responses by: identifying clusters of semantically similar responses based on their embedding vector distances; choosing responses from different clusters to maximize semantic diversity; prioritizing responses with higher weights within each cluster to emphasize coverage of low-reward regions; and verifying that selected responses maintain minimum pairwise distances in the embedding space to ensure semantic distinctness.

Example 22 is at least one machine-readable medium including instructions that, when executed by processing circuitry, cause the processing circuitry to perform operations to implement of any of Examples 1-21.

Example 23 is an apparatus comprising means to implement of any of Examples 1-21.

Example 24 is a system to implement of any of Examples 1-21.

Example 25 is a method to implement of any of Examples 1-21.

What is claimed is:

1. A computer-implemented method for training a language model, comprising:
identifying N candidate responses for an input query;
identifying reward scores for each of the N candidate responses;
selecting K responses from the N candidate responses, where K is less than N by:
identifying a highest-reward response as a positive example; and
selecting K−1 negative responses from remaining responses by one or more of:
selecting remaining responses with the lowest reward scores;
applying clustering to group the remaining responses based on corresponding embedding vectors and selecting a response from each cluster with a lowest reward score; or
selecting responses by weighting responses and assigning higher weights to responses with lower rewards, and selecting a subset of K−1 responses that minimizes weighted distances between responses while ensuring selected responses are semantically distinct from each other by selecting responses from different regions of an embedding space that clusters vector representations corresponding to the remaining responses based upon the weights;
calculating a mean reward score from the reward scores of the K selected responses;
computing deviations of each selected response's reward score from the mean reward score;
partitioning the K selected responses into positive and negative groups by assigning responses with deviations above the mean reward score to the positive group, and assigning responses with deviations below or equal to the mean reward score to the negative group;
assigning weights to each response based on its deviation from the mean reward score, wherein: responses with larger absolute deviations from the mean reward score are assigned higher weights than responses with smaller absolute deviations;
computing modified scores for each response by combining a base score with the assigned weight;
generating a weighted contrastive loss function based on the modified scores of the responses in the positive and negative groups; and
updating parameters of the language model by optimizing the weighted contrastive loss function.

2. The method of claim 1, wherein selecting K responses further comprises:
computing embedding vectors for each of the N candidate responses using a sentence encoder model.

3. The method of claim 1, wherein applying clustering comprises applying K-means clustering.

4. The method of claim 1, wherein assigning weights to each response comprises:
calculating absolute deviations from the mean reward score; and
applying a scaling factor a to control influence of the deviations on final weights.

5. The method of claim 1, wherein the reward scores are calculated using a reward model that is a pre-trained model that scores each response based upon an alignment with human preferences.

6. The method of claim 1, wherein identifying N candidate responses for an input query comprises using the language model to generate the N candidate response.

7. The method of claim 1, wherein selecting responses by optimizing coverage of low-reward regions while maximizing pairwise distances between embedding vectors comprises:
computing weights for each response that are inversely proportional to the response's reward score, such that responses with lower rewards receive higher weights;
calculating pairwise distances between embedding vectors in the embedding space to measure semantic similarity between responses;
selecting a subset of K−1 responses by:
identifying clusters of semantically similar responses based on their embedding vector distances;
choosing responses from different clusters to maximize semantic diversity;
prioritizing responses with higher weights within each cluster to emphasize coverage of low-reward regions; and
verifying that selected responses maintain minimum pairwise distances in the embedding space to ensure semantic distinctness.

8. A computing device for training a language model, the computing device comprising:
a hardware processor;
a memory, the memory storing instructions, which when executed by the hardware processor cause the computing device to perform operations comprising:
identifying N candidate responses for an input query;
identifying reward scores for each of the N candidate responses;
selecting K responses from the N candidate responses, where K is less than N by:
identifying a highest-reward response as a positive example; and
selecting K−1 negative responses from remaining responses by one or more of:
selecting remaining responses with the lowest reward scores;
applying clustering to group the remaining responses based on corresponding embedding vectors and selecting a response from each cluster with a lowest reward score; or
selecting responses by weighting responses and assigning higher weights to responses with lower rewards, and selecting a subset of K−1 responses that minimizes weighted distances between responses while ensuring selected responses are semantically distinct from each other by selecting responses from different regions of an embedding space that clusters vector representations corresponding to the remaining responses based upon the weights;
calculating a mean reward score from the reward scores of the K selected responses;
computing deviations of each selected response's reward score from the mean reward score;
partitioning the K selected responses into positive and negative groups by
assigning responses with deviations above the mean reward score to the positive group, and
assigning responses with deviations below or equal to the mean reward score to the negative group;
assigning weights to each response based on its deviation from the mean reward score, wherein: responses with larger absolute deviations from the mean reward score are assigned higher weights than responses with smaller absolute deviations;
computing modified scores for each response by combining a base score with the assigned weight;
generating a weighted contrastive loss function based on the modified scores of the responses in the positive and negative groups; and
updating parameters of the language model by optimizing the weighted contrastive loss function.

9. The computing device of claim 8, wherein the operations further comprise:
computing embedding vectors for each of the N candidate responses using a sentence encoder model.

10. The computing device of claim 8, wherein the operation of applying clustering further comprises applying K-means clustering.

11. The computing device of claim 8, wherein the operation of assigning weights to each response further comprises:
calculating absolute deviations from the mean reward score; and
applying a scaling factor aa to control influence of the deviations on final weights.

12. The computing device of claim 8, wherein the reward scores are calculated using a reward model that is a pre-trained model that scores each response based upon an alignment with human preferences.

13. The computing device of claim 8, wherein the operation of identifying N candidate responses for an input query further comprises using the language model to generate the N candidate responses.

14. The computing device of claim 8, wherein the operation of selecting responses by optimizing coverage of low-reward regions while maximizing pairwise distances between embedding vectors further comprises:
computing weights for each response that are inversely proportional to the response's reward score, such that responses with lower rewards receive higher weights;
calculating pairwise distances between embedding vectors in the embedding space to measure semantic similarity between responses;
selecting a subset of K−1 responses by:
identifying clusters of semantically similar responses based on their embedding vector distances;
choosing responses from different clusters to maximize semantic diversity;
prioritizing responses with higher weights within each cluster to emphasize coverage of low-reward regions; and
verifying that selected responses maintain minimum pairwise distances in the embedding space to ensure semantic distinctness.

15. A non-transitory machine-readable medium, storing instructions for training a language model, the instructions, which when executed, cause the machine to perform operations comprising:
identifying N candidate responses for an input query;
identifying reward scores for each of the N candidate responses;
selecting K responses from the N candidate responses, where K is less than N by:
identifying a highest-reward response as a positive example; and
selecting K−1 negative responses from remaining responses by one or more of:
selecting remaining responses with the lowest reward scores;
applying clustering to group the remaining responses based on corresponding embedding vectors and selecting a response from each cluster with a lowest reward score; or
selecting responses by weighting responses and assigning higher weights to responses with lower rewards, and selecting a subset of K−1 responses that minimizes weighted distances between responses while ensuring selected responses are semantically distinct from each other by selecting responses from different regions of an embedding space that clusters vector representations corresponding to the remaining responses based upon the weights;
calculating a mean reward score from the reward scores of the K selected responses;
computing deviations of each selected response's reward score from the mean reward score;
partitioning the K selected responses into positive and negative groups by
assigning responses with deviations above the mean reward score to the positive group, and
assigning responses with deviations below or equal to the mean reward score to the negative group;
assigning weights to each response based on its deviation from the mean reward score, wherein: responses with larger absolute deviations from the mean reward score are assigned higher weights than responses with smaller absolute deviations;
computing modified scores for each response by combining a base score with the assigned weight;
generating a weighted contrastive loss function based on the modified scores of the responses in the positive and negative groups; and
updating parameters of the language model by optimizing the weighted contrastive loss function.

16. The non-transitory machine-readable medium of claim 15, wherein the operations further comprise:
computing embedding vectors for each of the N candidate responses using a sentence encoder model.

17. The non-transitory machine-readable medium of claim 15, wherein the operation of applying clustering further comprises applying K-means clustering.

18. The non-transitory machine-readable medium of claim 15, wherein the operation of assigning weights to each response further comprises:
calculating absolute deviations from the mean reward score; and
applying a scaling factor aa to control influence of the deviations on final weights.

19. The non-transitory machine-readable medium of claim 15, wherein the reward scores are calculated using a reward model that is a pre-trained model that scores each response based upon an alignment with human preferences.

20. The non-transitory machine-readable medium of claim 15, wherein the operation of identifying NN candidate responses for an input query further comprises using the language model to generate the NN candidate responses.

21. The non-transitory machine-readable medium of claim 15, wherein the operation of selecting responses by optimizing coverage of low-reward regions while maximizing pairwise distances between embedding vectors further comprises:
computing weights for each response that are inversely proportional to the response's reward score, such that responses with lower rewards receive higher weights;
calculating pairwise distances between embedding vectors in the embedding space to measure semantic similarity between responses;
selecting a subset of K−1K−1 responses by:
identifying clusters of semantically similar responses based on their embedding vector distances;
choosing responses from different clusters to maximize semantic diversity;
prioritizing responses with higher weights within each cluster to emphasize coverage of low-reward regions; and
verifying that selected responses maintain minimum pairwise distances in the embedding space to ensure semantic distinctness.
